(19) United States
(12) Patent Application Publication
(10) Pub. No.: US 2018/0015701 A1
(43) Pub. Date: Jan. 18, 2018

(54) MONOWEB BARRIER FILMS FOR COLD-SEAL APPLICATIONS

(71) Applicant: Jindal Films Americas LLC, LaGrange, GA (US)

(72) Inventors: Benoît Ambroise, Hachy (BE); François Gastineau, Luxembourg (LU); Laurent Chantraine, Olm (LU)

(73) Assignee: Jindal Films Americas LLC, LaGrange, GA (US)

(21) Appl. No.: 15/545,746

(22) PCT Filed: Feb. 24, 2016
(86) PCT No.: PCT/US16/19390

§ 371 Date: Jul. 24, 2017

Related U.S. Application Data
(60) Provisional application No. 62/120,158, filed on Feb. 24, 2015.

(51) Int. Cl. B32B 27/08; B65D 65/40; C09J 7/02

(52) U.S. Cl. CPC B32B 27/08; C09J 7/0296; B65D 65/40; B32B 2255/10; B32B 2255/205; B32B 2250/24; B32B 2255/26

(57) ABSTRACT

Disclosed are compositions, structures, and methods for monoweb barrier films for cold-seal applications. The monoweb barrier film may include a core having a first side and a second side. Further, the monoweb barrier film may include a first skin layer immediate to the first side, wherein the first skin layer comprises an ethylene-vinyl-alcohol-based or a polyvinyl-alcohol-based coating that is receptive to one or more cold-seal adhesives. Further still, the monoweb barrier film may include a second skin layer immediate to the second side, wherein the second skin layer comprises a treated surface, wherein the first skin layer is antiblocking to the second skin layer in a reel.

### REFERENCE TO RELATED APPLICATION

The present application is a national-entry application, which claims priority to Patent Cooperation Treaty (PCT) application PCT/US16/19390 filed on Feb. 24, 2016, which claims priority to the U.S. provisional patent application Ser. No. 62/120,158 filed Feb. 24, 2015, wherein both of these priority applications are incorporated in their entireties and were titled the same as this application.

### FIELD

The disclosure relates to compositions, structures, and methods for monoweb barrier films for cold-seal applications.

### BACKGROUND

Materials laminated to a release film to form a cold seal are known. Known laminates, for instance, include use of a cold seal on a treated terpolymer of Jindal Films® Metallyte® 35MU842 (i.e., metal on ethylene vinyl alcohol (“EVOH”)) laminated to Jindal Films® Bicor® 18CSR-M as the release film. Another example is the use of a cold seal on Jindal Films® Oppalyte® of 45MW647 (i.e., acrylic) laminated to a 20 μm of oriented polypropylene (“OPP”) as the release film. The metallized EVOH or acrylic coating imparts an aroma-barrier protection.

The converter applies both a cold seal on the barrier film in order to permit sealing of heat-sensitive products, e.g., chocolate bars, and laminate to a release film in order to avoid blocking in a reel. These compositions and applications are described, in whole or in part, for example, in three references, namely U.S. Pat. No. 8,596,867, U.S. Pat. No. 8,815,377, and U.S. Pub. App. No. 2008/0223007, all of which are incorporated herein by this reference. Despite known laminates and applications, simplification and cost-efficiency have inspired alternative solutions that use a monoweb, impart aroma-barrier protection, and maintain appropriate release properties for the packaged product.

### SUMMARY

Disclosed are compositions, structures, and methods for monoweb barrier films for cold-seal applications. In one embodiment, there is a monoweb barrier film, which may include a core having a first side and a second side. Further, the monoweb barrier film may include a first skin layer immediate to the first side, wherein the first skin layer comprises an ethylene-vinyl-alcohol-based or a polyvinyl-alcohol-based coating that is receptive to one or more cold-seal adhesives. Further still, the monoweb barrier film may include a second skin layer immediate to the second side, wherein the second skin layer comprises a treated surface, wherein the first skin layer is antiblocking to the second skin layer in a reel.

In another example embodiment, a method may include receiving at least a monoweb barrier film described in the preceding paragraph, but, in other embodiments, the received monoweb film may include one or more layers, coatings, components, release liner, or combination thereof. The method continues by forming a package, a label, or a tag from the monoweb barrier film.

### BRIEF DESCRIPTION OF THE DRAWINGS

So that the manner in which the above recited features, advantages and objects of this disclosure are attained and may be understood in detail, a more particular description, briefly summarized above, may be had by reference to the embodiments thereof which are illustrated in the appended drawings.

It is to be noted, however, that the appended drawings illustrate only typical embodiments of this disclosure and are therefore not to be considered limiting of its scope, for the disclosure may admit to other equally effective embodiments.

FIG. 1 is a tabular format of an example embodiment of a film structure and compositions in accordance with this disclosure.

FIG. 2 a pictorial format of an example embodiment of a film structure and compositions in accordance with this disclosure.

FIG. 3 provides example embodiments of tie layers that may be used in film structures and compositions in accordance with this disclosure.

FIG. 4 provides example embodiments of film structures and compositions in accordance with this disclosure.

FIG. 5 shows measurements made on the example embodiments of film structures and compositions depicted in FIG. 4.

FIG. 6 shows cold-seal strength measurements made on various sample film structures and compositions containing a release lacquer (“RL”) in combination with example embodiments of film structures and compositions, such as those in FIG. 4, in accordance with this disclosure.

### DETAILED DESCRIPTION

This disclosure generally relates to compositions, structures, methods, packages, tags, labels, and so forth associated with a monoweb film packaging solution that may serve, for instance, as a replacement to laminates for products, such as foodstuffs, including chocolate bars, wherein the inventive packaging films and applications are sealed with re-closable cold seals. In one example embodiment, generally disclosed is a structure, which may be a 60 μm cavitated film, but in other example embodiments, the cavitated film may be thinner or thicker or simply not cavitated. In various embodiments, the films may run the gamut from clear to white and from translucent to opaque. Turning to the layers of the cavitated film in one example embodiment, one side of a first skin layer may include an EVOH-skin for aroma-barrier protection that may be coated with a cold-seal adhesive. The opposite side of the cavitated film may have a second skin layer and/or be treated, printed, metallized, or combinations thereof.

Surprisingly, the metal does not block against the EVOH-skin layer when both surfaces are in contact in a reel. The middle portion may contain a cavitated core, which may abut a first tie layer that abuts the EVOH-skin layer, and, optionally, the core may optionally abut a second tie layer, a treated skin, or combinations thereof, wherein the treating may optionally occur via corona discharge treatment, flame treatment, and/or otherwise.

The treated and/or metallized surface of the cavitated film may be printed and/or coated with a release lacquer to avoid blocking against the cold-seal coating. That treated layer may be homopolymers or copolymers of polyethylene (“PE”), polypropylene (“PP”), or blends thereof. Surprisingly, the EVOH-skin layer, besides providing aroma-barrier protection and blocking resistance against a surface treated layer or a metallized layer, is also a good receptive surface for cold-seal adhesives.

Additionally and alternatively, disclosed films that may be received and used, for example, to make a wide array of packaging, labeling, tagging, and other implementations; and such films may be coated, metallized, printed, or combinations thereof. Metallization may emanate, for example, from aluminum, AlOₓ, SiOₓ, and other sources. Coatings, for example, may be acrylic, polyvinylidene chloride (“PVDC”), or printable coatings, such as those used in conventional or digital printing.

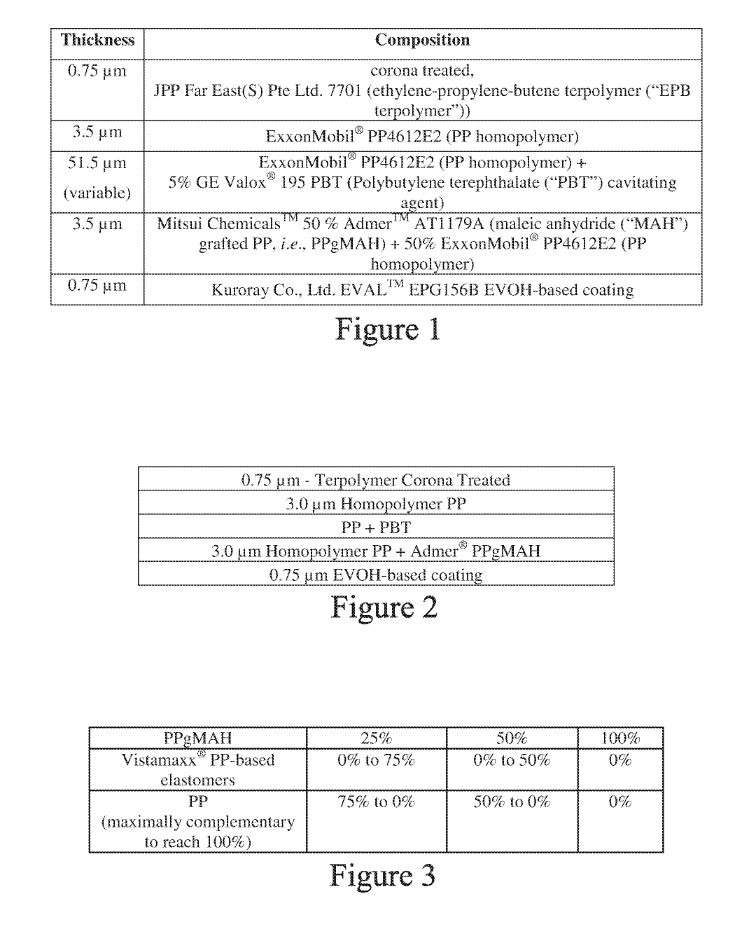

Moving on to a more particularized description of example embodiments, FIG. 1 provides in tabular format a film structure that may be coextruded and is compliant with the discussion herein. FIG. 2 depicts a similar example embodiment in a more pictorial format.

In yet additional example embodiments, the thickness of the EVOH layer may be much higher or lower, e.g., 0.1-5 μm, that that shown in FIGS. 1 and 2. In still further example embodiments, the coextruded EVOH layer may be replaced by one or more EVOH coatings, such as described in U.S. Pat. No. 7,473,439 and incorporated herein by this reference. That is, the film coatings of this disclosure incorporate at least one cross-linked EVOH copolymer comprising vinyl alcohol units and units derived from ethylene. For purposes of this disclosure, the terms “EVOH copolymer” and “ethylene vinyl copolymer” refer to EVOH-based polymers incorporating two or more monomers, including vinyl alcohol units and units derived from ethylene. For example, these terms, as used herein, include copolymers including units derived from ethylene and vinyl alcohol units, as well as one or more additional monomers present at levels up to 10 mol %. Exemplary additional monomers include alpha-olefins, such as propylene, 1-butene, isobutene and 1-hexene; vinyl ethers, such as methyl vinyl ether, ethyl vinyl ether, n-propyl vinyl ether, iso-propyl vinyl ether and n-butyl vinyl ether; hydroxyl group-containing vinyl ethers, such as ethylene glycol vinyl ether, 1,3-propanediol vinyl ether and 1,4-butanediol vinyl ether; allyl ethers, such as allyl acetate, propyl allyl ether, butyl allyl ether and hexyl allyl ether; monomers containing an oxyalkylene group; vinyl silanes, such as vinyltrimethoxysilane; hydroxyl group-containing alpha-olefins, such as isopropenyl acetate, 3-buten-1-ol, 4-penten-1-ol, 5-hexen-1-ol, 7-octen-1-ol, 9-decen-1-ol and 3-methyl-3-buten-1-ol; sulfonic acid group-containing monomers, such as ethylenesulfonic acid, allylsulfonic acid, methallylsulfonic acid and 2-acrylamide-2-methylpropanesulfonic acid; and cationic group-containing monomers, such as vinyloxyethyltrimethylammonium chloride, vinyloxybutyltrimethylammonium chloride, vinyloxyethyldimethylamine, vinyloxymethyldiethylamine, N-acrylamidemethyltrimethylammonium chloride, 3-(N-methacrylamide)propyltrimethylammonium chloride, N-acrylamideethyltrimethylammonium chloride, N-acrylamidedimethylamine, allyltrimethylammonium chloride, methallyltrimethylammonium chloride, dimethylallylamine, and allylethylamine.

Additionally and alternatively, the coextruded EVOH layer may be replaced by one or more EVOH coatings, such as one or more polyvinyl alcohol (“PVOH”) coatings, such as one described in U.S. Pat. No. 6,444,750 and incorporated herein by this reference. For example, the PVOH may include a crosslinking-promoting acid catalyst, such as phosphoric, nitric, hydrochloric or maleic acids, and a crosslinking agent, such as a melamine formaldehyde, in an aqueous solution. The PVOH may have a low viscosity and be superhydrolyzed. However, other commercially available PVOHs, e.g., Elvanol® 7130 produced by DuPont®, are acceptable. Moreover, the coextruded EVOH layer may be replaced by alternated EVOH and PVOH coatings, or one or more coatings of an EVOH/PVOH coating, wherein the coatings are in a solution or dispersion. In various, alternative example embodiments, coating(s) may be applied in-line, out-of-line or combinations thereof.

FIGS. 1 and 2 show a cavitated PP core layer, but in other example embodiments, the core layer may additionally or alternatively include PE, such as in example forms of HDPE and LLDPE, optionally metallocene-catalyzed, polyethylene terephthalate (“PET”), and combinations of any of the foregoing. Furthermore, in other example embodiments, the core may be uncavitated (i.e., not contain polybutylene terephthalate (“PBT”) as in FIGS. 1 and 2) or include alternative cavitating agents, such as discussed at other portions of this disclosure.

Various additives, such as pigments, processing aids, extrusion aids, antiblocks, slip additives, antistatic additives, or other additives may be included in any of the film's layers. In one example, TiO₂ pigment added to the tie layer, which is under the corona-treated skin layer, improves the whiteness of the corona-treated skin layer that may be used, for instance, by the converter as a print surface as previously disclosed. In another example embodiment, one or more fluoropolymers are added to the EVOH layer.

The cavitating or void-initiating additives may include any suitable organic or inorganic material that is incompatible with the core layer polymer material. Examples of suitable cavitating agents besides or in addition to PBT used in FIGS. 1 and 2 are nylon, solid or hollow preformed glass spheres, metal beads or spheres, ceramic spheres, CaCO₃, talc, chalk, etc., or combinations thereof. The average diameter of the void-initiating particles typically may be from 0.1 to 10 μm. These void initiating particles may be present in the core layer at less than 30 wt %, preferably less than 25 wt %, most preferably in the range of from 2-20 wt %, based on the total weight of the core layer. More or less than 5% GE Valox® 195 PBT as the cavitating agent or other types of suitable cavitating agents may be used in order to adjusted, as desired, the cavitation/density of the film, a variation that may produce films having different stiffnesses and EVOH-skin adhesions.

Turning to the tie layer abutting the EVOH-skin layer in the example embodiment depicted at FIG. 2, the maleic anhydride-grafted PP (“PPgMAH”) may be present in various example embodiments within a range of from 25 to 100 wt % of that tie layer. PPgMAH may improve the EVOH-skin layer's adhesion. A PP-based elastomer, for example and such as ExxonMobil® Vistamaxx®, may be used as well within a range of about 0 to 75%, with an aim at mitigating, if not avoiding all together, skin delamination when cold seals are opened.

FIG. 3 depicts alternative, example embodiments of the one or more tie layers of the disclosed compositions for applications. Using FIG. 3, one may see that various tie layer compositions may be formed based on a combination of the two primary components, PPgMAH and 55% Vistamaxx® (or other PP-based elastomer). By way of an example to further explain, if 25% PPgMAH and 55% Vistamaxx® are used, then the maximum complementary amount of PP for the remainder of this tie layer composition is 20%, wherein maximum complementary amount is the terminology used in case there are no other additives, such as those disclosed herein or of a type known in the art, to the tie layer. If such additives are added to this example, then the complementary amount of PP is less than the maximum complementary amount of 20% by weight of the tie layer.

In other example embodiments, possible tie layers below the EVOH layer may be those such as described in U.S. Pat. No. 5,153,074 and incorporated herein by this reference. Additionally and alternatively, the tie layer below the treated skin may be other than PP homopolymer, such as a PP copolymer, PE, or combinations PP homopolymer, copolymer(s), and/or PE.

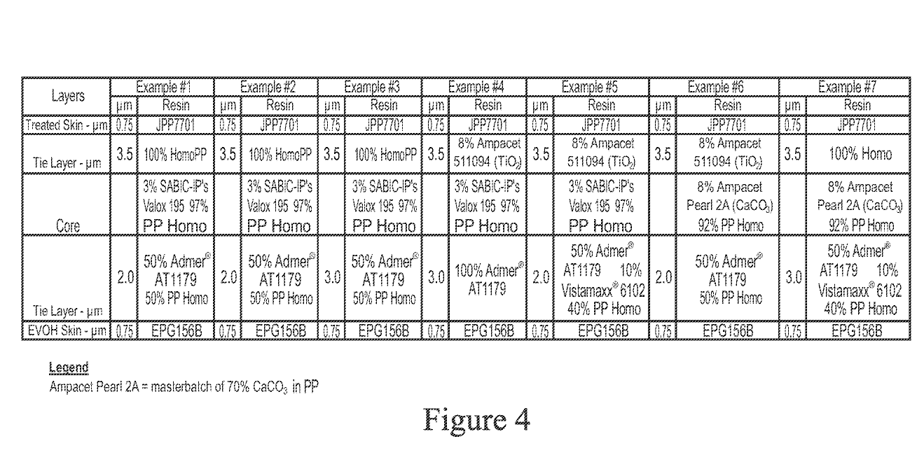

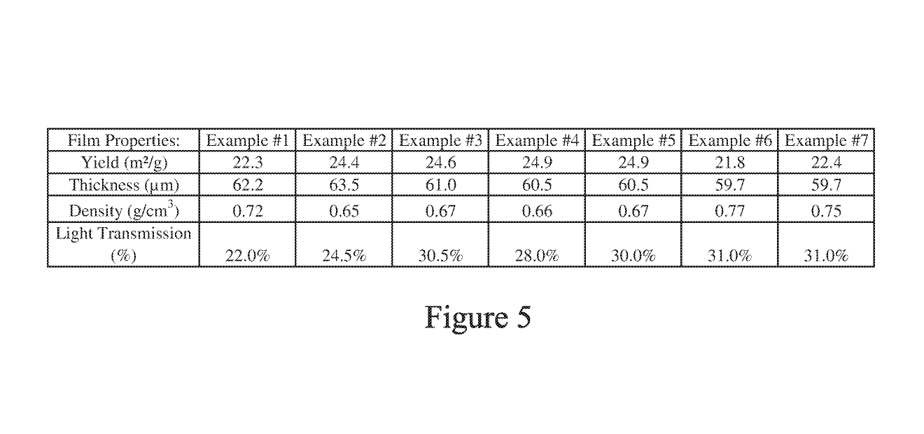

FIG. 4 depicts film structures that are consistent with those shown at and described in relation to FIGS. 1 and 2. FIG. 5 summarizes measurements made on the experimental monoweb barrier film, i.e., films, outlined in FIG. 4. Densities of the experimental films were calculated by dividing the weight of an experimental film by the thickness of the experimental film, wherein thickness, i.e., optical gauge, was measured with a micrometer. Light transmission measurements were made according to ASTM D1003.

The terpolymer-treated surface of the films in this disclosure was converted by printing and coating with a release lacquer (“RL”), such as 10-609596-1.1650, which is available from Siegwerk®. The EVOH-based skin layer was coated with a cold-seal in pattern, e.g., Sun Chemical™'s CS8113 applied at 3.8 g/m², but other patterns and laydown amounts may vary in other embodiments.

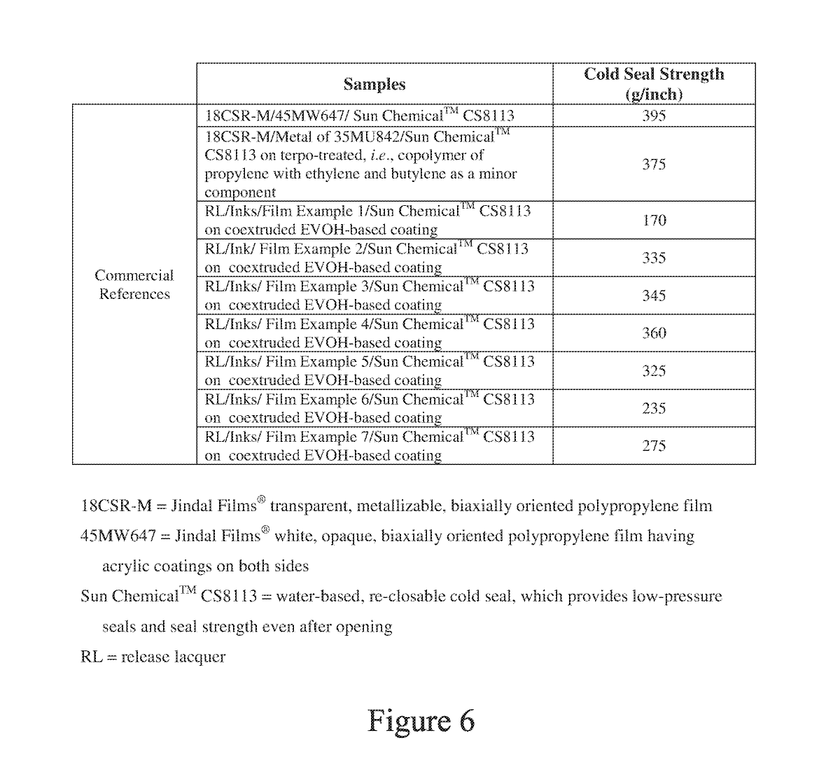

Finally, with reference to FIG. 6, depicted is a tabular summary of room-temperature, cold-seal strength measurements using an Otto Brugger sealer (pressure=60 N/cm² or 600 kPa with dwell time at 1 s at temperature of 23° C.) for commercial films as well as experimental films, i.e., films now presented by way of this disclosure, such as those disclosed in FIGS. 1-5. Cold-seal strength measurements were made according to ASTM F2029.

The experimental films demonstrated similar cold-seal performance as compared to commercial films having standard surfaces, such as treated biaxially oriented PP (“BOPP”) and acrylic-coated BOPP. In other example embodiments, the films are only monoaxially oriented.

While the foregoing is directed to example embodiments of the disclosed invention, other and further embodiments may be devised without departing from the basic scope thereof, wherein the scope of the disclosed applications, compositions, structures, labels, methods, and so forth are determined by the claims.

1. A monoweb barrier film comprising:
a core having a first side and a second side;
a first skin layer immediate to the first side, wherein the first skin layer comprises an ethylene-vinyl-alcohol-based or a polyvinyl-alcohol-based coating that is receptive to one or more cold-seal adhesives; and
a second skin layer immediate to the second side, wherein the second skin layer comprises a treated surface,
wherein the first skin layer is antiblocking, without an antiblocking agent, to the second skin layer in a reel.

2. The monoweb barrier film of claim 1, further comprising one or more tie layers between the core and at least member of a group consisting of the first skin layer, the second skin layer, and both.

3. The monoweb barrier film of claim 2, wherein the one or more tie layers comprises polypropylene polymers, polyethylene polymers, polymers grated with maleic anhydride, or combinations thereof.

4. The monoweb barrier film of claim 1, wherein the core comprises polypropylene, polyethylene, polyethylene terephthalate, or combinations thereof.

5. The monoweb barrier film of claim 1, wherein the core comprises a cavitating agent.

6. The monoweb barrier film of claim 1, wherein the second skin layer comprises one or more ethylene-propylene-butylene terpolymers.

7. (canceled)

8. The monoweb barrier film of claim 1, wherein the treated surface comprises treatment by corona-discharge or flame.

9. The monoweb barrier film of claim 1, wherein the monoweb barrier film is clear or whitish.

10. The monoweb barrier film of claim 1, wherein the monoweb barrier film is translucent or opaque.

11. The monoweb barrier film of claim 1, further comprising a printable coating on the first skin layer on a side opposite the core.

12. The monoweb barrier film of claim 1, further comprising a metallized layer on the first skin layer on a side opposite the core.

13. The monoweb barrier film of claim 1, further comprising a coating on the first skin layer on a side opposite the core, wherein the coating comprises a release lacquer.

14. The monoweb barrier film of claim 1, further comprising the one or more cold-seal adhesives on the first skin layer on a side opposite the core.

15. The monoweb barrier film of claim 14, wherein the one or more cold-seal adhesives are re-closeable.

16. The monoweb barrier film of claim 14, wherein the one or more cold-seal adhesives have a cold-seal strength of at least 170 g/25.4 mm at a temperature of 23° C. and a pressure of 60 N/cm² for a crimping duration of 1 second.

17. The monoweb barrier film of claim 1, wherein the monoweb barrier film has a light transmission of at least 22%.

18. The monoweb barrier film of claim 1, wherein the monoweb barrier film has a density between 0.6 g/cm³ and 0.8 g/cm³.

19. The monoweb barrier film of claim 1, further comprising one or more additives in one or more layers of the monoweb barrier film.

20. A method comprising receiving at least the monoweb barrier film of claim 1, wherein the at least the monoweb barrier film optionally comprises one or more layers, coatings, components, release liner, or combination thereof; and forming a package, a label, or a tag from the monoweb barrier film.

21. The monoweb barrier film of claim 1, wherein the first skin layer further comprises one or more crosslinking-promoting acid catalysts, crosslinking agents, or both.
